(19) United States
(12) Patent Application Publication
(10) Pub. No.: US 2004/0034659 A1
(43) Pub. Date: Feb. 19, 2004

(54) Automated policy compliance management system

(76) Inventor: Kevin J. Steger, Portland, OR (US)

Correspondence Address: SCHWABE, WILLIAMSON & WYATT, P.C., PACWEST CENTER, SUITES 1600-1900, 1211 SW FIFTH AVENUE, PORTLAND, OR, 97204, US

(21) Appl. No.: 10/224,309

(22) Filed: Aug. 19, 2002

(51) Int. Cl. G06F 17/00

(52) U.S. Cl. 707/104.1

(57) ABSTRACT

The invention includes computer instructions that operate to receive change of a person within an organization. The received change having employee information corresponding to the change of the person. The computer instructions store the received employee information corresponding to the change of the person in a database. Once the received employee information corresponding to the change of the person is stored, the computer instructions update the database with the received employee information corresponding to the change of the person. Once the database is updated, the instructions automatically provide, to the person, one or more policies for compliance certification, based at least in part on relevant parts of the updated employee information, to facilitate the organization's compliance with the one or more policies.

### FIELD OF INVENTION

The present invention relates to the fields of policy compliance management and data processing. More specifically, the present invention relates to an automated policy compliance management system, having particular application to human resource policy compliance management.

### BACKGROUND OF THE INVENTION

Policy compliance management has become an important aspect of organizations both large and small alike, especially in the area of human resource management.

A large part of human resource management relates to ensuring that persons of the organization are made aware of, and comply with, various policies of the organization. For example, in a manufacturing business setting, the business may be required to comply with occupational safety and health administration (OSHA) requirements, which are governmentally mandated requirements. In order for the business to comply with these requirements, commonly the business requires persons to receive and review the OSHA policy materials, and comply accordingly. Compliance with the policies may require the person to receive and review a training manual, and manually complete policy forms to acknowledge that the person has complied with his/her training requirements. The person's compliance, in turn, facilitates the business's compliance with the OSHA requirements.

An organization's compliance with various human resource policies not only facilitates the organization's compliance with governmentally mandated requirements, but also improves the organization's avoidance of legal issues that may arise out of not complying with human resource policies. For example, various legal issues may arise out of the fact that a person was not aware of a policy regarding drug and alcohol, where disciplinary action was taken against the person. Had the organization been in compliance with the drug and alcohol policy (i.e., the person being made aware of and acknowledging the policy), the organization would have a better chance of avoiding these types of legal issues. Accordingly, an organization's compliance with various human resource policies is very important. However, ensuring that this compliance occurs within in an organization is very complicated and difficult.

A difficulty with compliance with various human resource policies may be that an organization may have people performing many functions, and in many different locations. Trying to ensure that all personnel of all organization units and/or locations comply with various human resource policies is very complex and difficult, especially, since the policies may differ from location to location, from function to function, and so forth. For example, a person may move from an organization's office in California to the organization's office in Oregon resulting in the person having to comply with additional or new human resource policies for Oregon.

Compliance with an organization's human resource policies may be based at least in part on the person's role in the structure of the organization. In another example, a person in a supervisory role in the organization (i.e., has person(s) that report to him/her) may be required to comply with different human resource policies than that required by the person(s) that report to him/her. Likewise, a person who at one time may have reported to a person in a supervisory role, may have his/her role changed to become a person in a supervisory role himself/herself requiring that he/she comply with additional or new human resources policies.

Accordingly, a need exists for an improved way of facilitating compliance with various policies for an organization, in particular, in the area of human resource management.

### BRIEF DESCRIPTION OF DRAWINGS

The present invention will be described by way of exemplary embodiments, but not limitations, illustrated in the accompanying drawings in which like references denote similar elements, and in which:

FIG. 1 illustrates an exemplary environment within which the present invention may be practiced, in accordance with one embodiment;

FIG. 2 illustrates the operational flow of the relevant aspects of policy compliance management system utilizing functionality, in accordance with one embodiment of the present invention;

FIG. 3 illustrates the operational flow of the relevant aspects of PCMS utilizing functionality, in accordance with another embodiment of the present invention;

FIG. 4 illustrates the operational flow of the relevant aspects of PCMS utilizing functionality, in accordance with another embodiment of the present invention;

FIG. 5 illustrates the operational flow of the relevant aspects of PCMS utilizing functionality, in accordance with another embodiment of the present invention;

FIGS. 6A-6B illustrate data structure suitable to support the present invention, in accordance with one embodiment; and

FIG. 7 illustrates one embodiment of a computer system suitable to be programmed with the PCMS of the present invention.

### DETAILED DESCRIPTION OF THE INVENTION

In the following description, for ease of understanding, the present invention will be primarily presented in the context of human resource policy compliance management, however, the present invention is not so limited, and may be practiced to streamline and improve the efficiency of managing other policy compliance.

Various aspects of the present invention will be described. However, it will be apparent to those skilled in the art that the present invention may be practiced with only some or all aspects of the present invention. For purposes of explanation, specific numbers, materials and configurations are set forth in order to provide a thorough understanding of the present invention. However, it will also be apparent to one skilled in the art that the present invention may be practiced without the specific details. In other instances, well-known features are omitted or simplified in order not to obscure the present invention.

Parts of the description will be presented in terms of operations performed by a computer system, using terms such as data, flags, bits, values, characters, strings, numbers and the like, consistent with the manner commonly employed by those skilled in the art to convey the substance of their work to others skilled in the art. As well understood by those skilled in the art, these quantities take the form of electrical, magnetic, or optical signals capable of being stored, transferred, combined, and otherwise manipulated through mechanical and electrical components of the computer system; and the term computer system include general purpose as well as special purpose data processing machines, systems, and the like, that are standalone, adjunct or embedded.

Various operations will be described as multiple discrete steps in turn, in a manner that is most helpful in understanding the present invention, however, the order of description should not be construed as to imply that these operations are necessarily order dependent. In particular, these operations need not be performed in the order of presentation.

Reference throughout this specification to “one embodiment” or “an embodiment” means that a particular feature, structure, or characteristic described in connection with the embodiment is included in at least one embodiment of the invention. Thus, the appearances of the phrases “in one embodiment” or “in an embodiment” in various places throughout this specification are not necessarily all referring to the same embodiment or invention. Furthermore, the particular features, structures, or characteristics may be combined in any suitable manner in one or more embodiments.

In various embodiments of the invention, compliance with various policies of an organization is facilitated. This and other advantages will be evident from the disclosure.

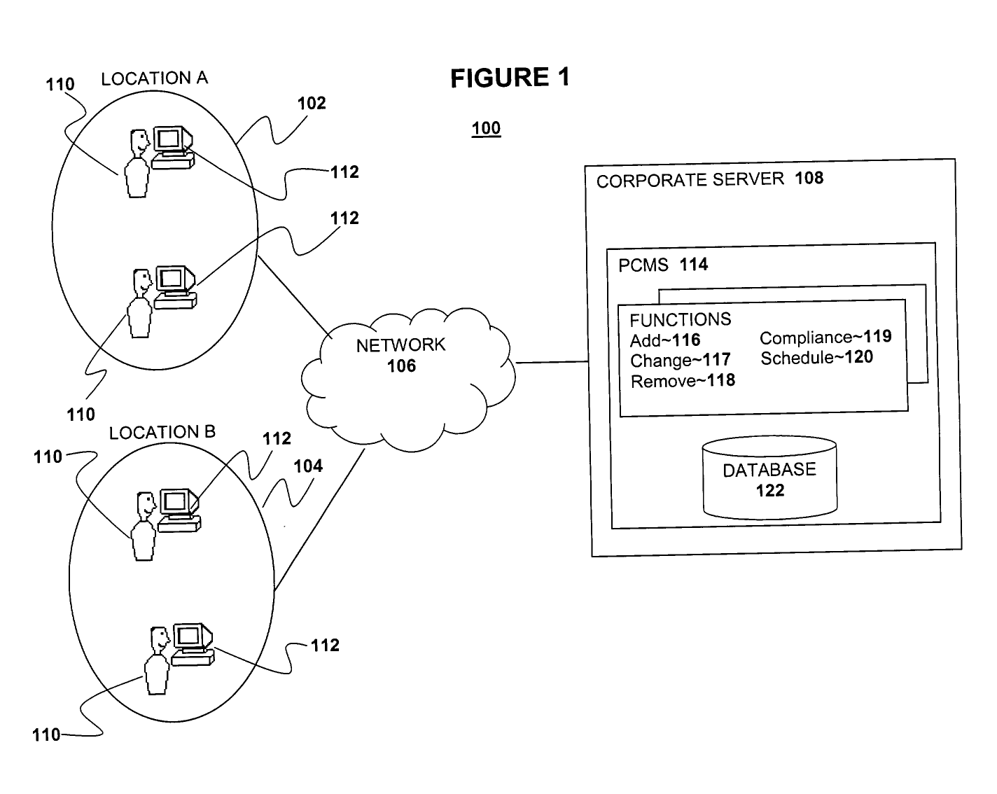

FIG. 1 illustrates an example environment within which the present invention may be practiced, in accordance with one embodiment. Environment in FIG. 1 may be a networking environment 100 of an organization facilitating communication with various devices belonging to the organization. In FIG. 1, networking environment 100 includes a first location 102 and a second location 104, both communicatively coupled to a network 106. Through network 106, the first and second locations 102 & 104 are further communicatively coupled to a corporate server 108.

Included in the first and second locations 102 & 104, are representations of persons 110 that work for the organization, hereon out, referred to as employees. Additionally, employees 110 are shown having client devices 112 through which policies may be graphically displayed to employees 110, and receive inputs associated with the policies from the employees 110.

In accordance with one embodiment, corporate server 108 is advantageously provided with a compliance management system (PCMS) 114. PCMS 114 includes various functions 116-120 facilitating various functionalities of the PCMS 114. Additionally, PCMS 114 includes a database 122 to facilitate support of the operation of the function blocks 116-120 under the control of the PCMS 114.

In FIG. 1, corporate server 108 operates to provide and receive various inputs regarding policies of the organization from various client devices 112 at various locations 102 & 104. Under the control of PCMS 114, database 122 operates to store various information associated with employees 110 and policies.

As will be described in further detail below, once information associated with employees 110 and policies are stored, PCMS 114 utilizes the various functions 116-120 supported by the database 122 to facilitate compliance with the policies. Having the PCMS 114 utilize the various functions 116-120, advantageously provides for a more simplified and efficient way of facilitating an organization's compliance with policies, such as human resource policies, even when an employee is added to the organization, and/or when changes are made to the employee's status (i.e., job description, location, and the like). Additionally, fulfillment of the compliance with policies is also facilitated including reminder scheduling (i.e., compliance and scheduling functions).

In various embodiments of the present invention, as previously alluded to, PCMS 114 includes functionality to facilitate compliance with policies corresponding to adding an employee to the organization (i.e., employee add function 116).

In various embodiments, PCMS 114 includes functionality to facilitate compliance with policies corresponding to various changes in the employee's status, job description, location, and the like, within the organization (i.e., employee change function 117).

In various embodiments, PCMS 114 includes functionality to facilitate compliance with policies corresponding to removing an employee from the organization (i.e., employee remove function 118).

In various embodiments, PCMS 114 includes functionality to facilitate compliance with policies corresponding to ensuring that the employee fulfills their compliance requirements, such as, training, acknowledging form, filling out forms, and the like, (i.e., employee compliance function 119).

In various embodiments, PCMS 114 includes functionality to facilitate compliance with policies corresponding scheduling of reminders to ensure that the employee fulfills their compliance requirements (i.e., reminder scheduling function 120).

Networking environment 106 may be any one of networking environments utilized by organizations, such as a local area network (LAN), and Internet, a wide area network (WAN), and so forth. It follows that the two locations 102 & 104 and the corporate server 108, shown communicatively coupled to the network 106, may each be located in close proximity to each other, e.g., same office, within a single building, or be located far from each other, e.g., different states, countries, and so forth. Further, networking environment 100 may include numerous locations, numerous persons, and numerous corporate servers. Except for the novel manner in which compliance with policies are automatically facilitated under the teachings of the present invention, networking environments of organizations are well known, accordingly, will not be described in further details.

Additionally, employees 110 may have hierarchical relationships, such as, but not limited to, supervisory roles. As alluded to earlier, and as will be described in further details, supervisory roles of the employees 110 may require compliance with policies that are different from compliance required by employees that report to the employees having a supervisory role. Except for the manner in which the teachings of the present invention facilitates compliance with policies for supervisors and employees, hierarchical relationships between persons in an organization are known, accordingly, will not be described in further details.

Before proceeding to further describe the present invention, it should be noted again, while for ease of explanation, the descriptions are presented primarily in the context of compliance with human resource policies, however, based on the description to follow, a person skilled in the art will appreciate that the present invention may be adapted for other applications besides compliance with human resource policies. Additionally, for ease of understanding, persons are presented in terms of employees of an organization. However, based on the description to follow, it should be appreciated that persons may be any type of association of persons, and does not necessarily need to be employed by an organization.

In various embodiments, PCMS 114 may be implemented in software and/or hardware. For example, one or more application specific integrated circuits (ASICs) could be programmed with one or more of the above described functions of the present invention. In another example, one or more functions of the present invention could be implemented in one or more ASICs on additional circuit boards and the circuit boards could be inserted into computer(s) to be described below. In another example, field programmable gate arrays (FPGAs) or static programmable gate arrays (SPGA) could be used to implement one or more functions of the present invention. In yet another example, a combination of hardware and software could be used to implement one or more functions of the present invention.

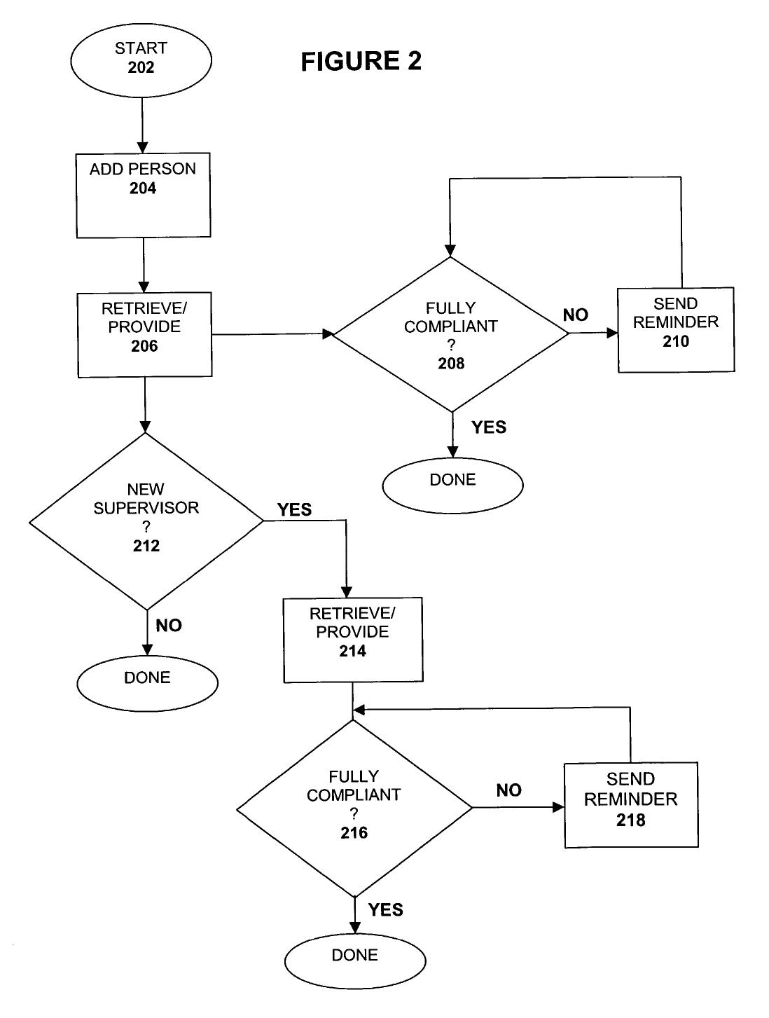

FIG. 2 illustrates the operational flow of the relevant aspects of PCMS 114 (shown in FIG. 1) utilizing add functionality, in accordance with one embodiment of the present invention. For the illustrated embodiment, PCMS 114 (shown in FIG. 1) is programmed in an event driven model (i.e., functions 116-120 of the PCMS 114 are designed to be executed in a system environment where various notification services are available from the operating system). One example of such an operating system suitable for practicing the invention is the Windows® NT operating system, available from Microsoft Corporation of Redmond, Wash. As previously described, in alternate embodiments, PCMS 114 may be implemented in other programming approaches known in the art.

In FIG. 2, at 202, PCMS 114 invokes employee add function 116 (shown in FIG. 1). The employee is added to the organization, block 204. As previously described, adding of the employee may involve storing employee information, such as, employee's ID number, name, location, supervisor, function/department, and so forth, into the database 122. Additionally, under the control of the PCMS 114, database 122 stores various policy information, such as, policy ID number, policy name, which employees require which policy (i.e., criteria for certain policies), and pointers/pathnames to various policies (i.e., where on a storage medium the policies reside).

Once the added employee's information is stored in the database 122, PCMS 114 retrieves relevant employee information and provides the appropriate policies and/or training materials to the added employee for compliance certification facilitating compliance with the policies, block 206.

For example, as part of the relevant employee information, PCMS 114 may retrieve information that the added employee's function is to operate a forklift in the organization's warehouse department. Accordingly, from the policy information, PCMS 114 determines that the added employee meets the criteria for at least a policy named occupational safety and health administration (OSHA). That is, employees that operate machinery in the organization's warehouse department are required to comply with the OSHA policy. Compliance with OSHA policy may involve training, which may include a training manual being provided to the employee, and may also involve the employee filling out forms to verify that the employee completed the training, and so forth. The OSHA policy may have a policy number associated with it, and the policy number would then be included in the employee's information. Thus, PCMS 114 may retrieve the appropriate human resources policies, training manuals, forms, and so forth, via pointer/pathnames stored in the database 122 for policy information, and provide them to the new employee via the network 106 (shown in FIG. 1) facilitating compliance with the policy, in accordance with various embodiments of the present invention.

Continuing to refer to FIG. 2, once all of the policies have been retrieved and provided to the employee for compliance certification, the PCMS 114 invokes employee compliance function 119 to determine if compliance with the policies have been fully met (i.e., employee has fully certified compliance), block 208. If it is determined that compliance with the policies have not been fully met, PCMS 114 invokes reminder scheduling function 120 to schedule periodic reminders to the employee, block 210.

However, if at block 208, it is determined that compliance with the policies have been fully met, no further action need to taken with regards to compliance with the policies.

Back at block 206, the appropriate policies for the employee may require additional policies applicable to those employees having supervisory roles be complied. Accordingly, PCMS 114 determines if the added employee also has a supervisory role in the organization and/or the added employee's supervisor has assumed the supervisory role for the first time, block 212. If it is determined that the added employee has a supervisory role and/or his/her supervisor assumed the supervisory role for the first time, PCMS 114 retrieves and provides the appropriate additional policies for compliance certifcation applicable to employees having supervisory roles, block 214.

However, at block 212, if it is determined that the added employee does not also have supervisory roles in the organization, nor his/her supervisor being assumed the supervisory role for the first time, no further action need to taken with regards to compliance with policies because all the required policies have already been retrieved and provided to the employee (i.e., no additional policies are required).

Once the appropriate additional policies applicable to employees having supervisory roles are provided, here again, the PCMS 114 invokes employee compliance function 119 to determine if compliance with the additional policies have been fully met (i.e., employee has fully certified compliance), block 216. If it is determined that compliance with the additional policies have not been fully met, PCMS 114 schedules periodic reminders to the employee, thereby invoking reminder scheduling function 120 until full compliance with the additional policies are met, block 218.

However, if at block 216, it is determined that compliance with the additional policies applicable to employees having supervisory roles have been fully met, no further action need to taken with regards to compliance with policies.

As a result, compliance with policies is facilitated when an employee is added to an organization. Additionally, if the added employee has supervisory roles, compliance with additional policies are also facilitated.

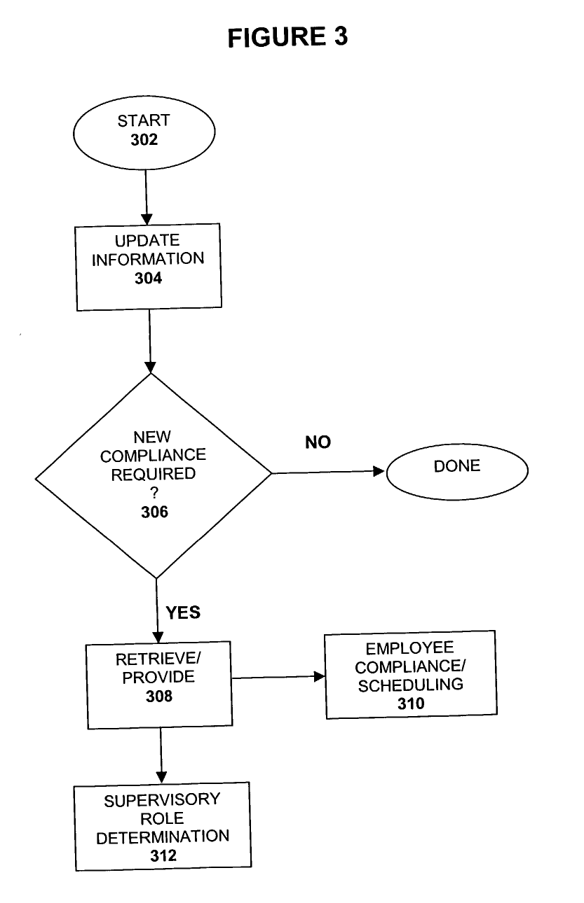

FIG. 3 illustrates the operational flow of the relevant aspects of PCMS 114 (shown in FIG. 1) utilizing change functionality, in accordance with another embodiment of the present invention. In FIG. 3, at 302, employee change function 117 of PCMS 114 is invoked upon PCMS 114 receiving a change in an employee's information. Once a change in an employee's information is received, under the control of the PCMS 114, the employee's information stored in the database 122 is updated to reflect the change, block 304.

Once the employee's information has been updated, PCMS 114 determines if compliance with new policies are required in response to the updated employee's information, block 306.

For example, referring back to the previous example of the employee operating a forklift in an organization's warehouse department, the employee may have been promoted to have a supervisory role in a marketing department in a different state within the organization, and is no longer required to operate a forklift. Accordingly, the employee's information may be updated to reflect the change, e.g., a supervisory role in a different state.

If it is determined that compliance with new policies are required in response to the updated employee's information, PCMS 114 retrieves the relevant updated employee information and provides the appropriate new policies for compliance certification to the employee whose status has changed compliance with the new policies, block 308. For the example above, the new policies may include policies for the marketing department, and additional policies for the employee having supervisory roles. No longer would the OSHA policy apply to the employee, and the employee information stored in the database 122 is updated accordingly.

However, if it is determined that compliance with new policies are not required, no further action need to taken with regards to compliance with policies.

Once all of the new policies have been retrieved and provided to the changed employee, the PCMS 114 invokes employee compliance function 119, and the reminder scheduling function 120, block 310. Operational flow of the relevant aspects of the compliance function 119 and the reminder scheduling function 120, in accordance with one embodiment of the present invention, have been previously described with respect to FIG. 2, and accordingly, need not be further described.

Additional policies applicable to those employees having supervisory roles may be required. Accordingly, PCMS 114 determines if the changed employee also has a supervisory role in the organization or his/her new supervisor assumes the supervisory for the first time, and upon so determining, PCMS 114 retrieves and provides the appropriate additional policies applicable to employees having supervisory roles, block 312. Operational flow of the relevant aspects of the compliance with additional policies applicable to those employees having supervisory roles have been previously described with respect to FIG. 2, accordingly, need not be further described.

Referring to the example of the changed employee who now has a supervisory role in a different state, compliance with new policies may mean that compliance with policies corresponding to the different state may be required, such as, the new state may prohibit drug testing. That is, compliance with policies may be different for various locations, accordingly, policy information includes policies to ensure compliance for each location. Additionally, because the changed employee has supervisory roles, compliance with additional policies corresponding to employees having supervisory roles is required, such as, how much time the employee in the supervisory role may give to an another employee for maternity leave. Likewise, the employee is no longer required to comply with policies regarding OSHA because the employee may no longer operates a forklift and no longer is at the organization's warehouse department.

Referring back to block 304, in one embodiment, the updated employee's information may be that the employee has been removed from the organization invoking employee remove function 118 (shown in FIG. 1). In response, PCMS 114 removes the employee from the organization. Except for the novel aspect of the utilization of the change function 117, removing an employee from an organization is well within ability of those skilled in the art, accordingly, will not be described in further details.

As a result, compliance with human resources policies is facilitated when various changes corresponding to an employee's status, job description, location, and the like, within the organization, occurs.

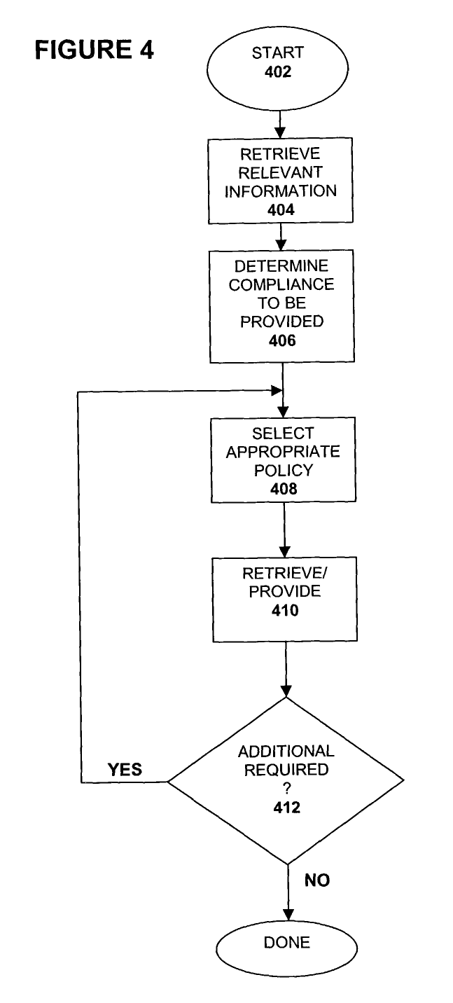

FIG. 4 illustrates the operational flow of the relevant aspects of PCMS 114 (shown in FIG. 1) utilizing compliance functionality, in accordance with another embodiment of the present invention. Illustrated in FIG. 4, compliance functionality, previously described for blocks 206, 214, and 308 (shown in FIGS. 2 & 3), is described in further details. In FIG. 4, at 402, employee compliance function 119 of PCMS 114 is invoked (shown in FIG. 1).

Once invoked, PCMS 114 retrieves the relevant employee information from the employee information stored in the database 122, block 404. Thereafter, PCMS 114 determines the appropriate required policy based at least in part on the relevant employee information from the policy information also stored in the database 122, block 406. For example, briefly referring back to the example of the employee that operates a forklift at the organization's warehouse department, the relevant employee's information that the employee operates a forklift will require the employee to comply with the OSHA policy.

Once PCMS 114 determines the appropriate required policy based at least in part on the relevant employee information, PCMS 114 selects the appropriate required policy from the policy information stored in the database 122 (shown in FIG. 1), block 408. As previously alluded to, selection of the appropriate policy involves PCMS 114 retrieving the appropriate policy, and any other policy materials, such as, training manuals and so forth, via the pointer/pathname for the appropriate policy within the database 122. Once selected, the policy is provided to the appropriate employee through the network 106 (shown in FIG. 1) for compliance certification, block 410. Providing the policy to the employee may be accomplished by any means, such as, graphically generating and displaying the policy at the employee's client device 112 (shown in FIG. 1). Generating and displaying policies are well within the ability of those skilled in the art, accordingly, will not be further described.

Thereafter, PCMS 114 determines if additional policies are required to be provided to the employee to facilitate compliance, block 412. If it is determined that additional policies are required, PCMS 114 selects the appropriate additional policy from the policy information stored in the database 122. However, if it is determined that additional policies are not required, no further action need to taken with regards to compliance with policies.

As a result, compliance with human resource policies is facilitated for numerous employees within an organization.

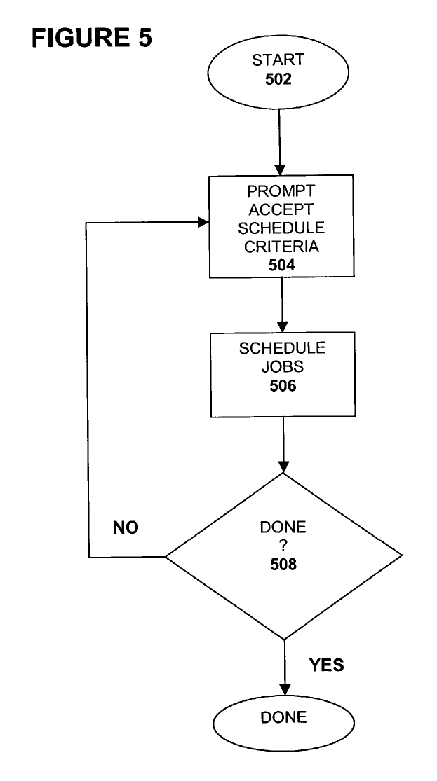

FIG. 5 illustrates the operational flow of the relevant aspects of PCMS 114 (shown in FIG. 1) utilizing reminder scheduling functionality, in accordance with another embodiment of the present invention. Illustrated in FIG. 5, reminder scheduling function, previously described for blocks 210 & 218 (shown in FIG. 2), is described in further details. In FIG. 5, at 502, reminder scheduling function 120 of PCMS 114 is invoked (shown in FIG. 1).

Once invoked, PCMS 114 prompts and accepts schedule criteria for various policies, locations, employees, and so forth, block 504. The schedule criteria is preferably configurable by a person that may be in charge of the organization's compliance with human resources policies, such as, but not limited to, a human resources administrator. Alternatively, the schedule criteria may be based at least in part on the type of policy for which compliance is required. For example, referring back to the employee that operates a forklift, because the employee operates a forklift requiring compliance with OSHA policies, the criteria for reminder scheduling of the OSHA policy may be met due to its relative importance.

Once the criteria for reminder scheduling is met, the reminders are scheduled accordingly (i.e., times, dates, months, and so forth), block 506. As with the reminder scheduling criteria, the scheduling may also be based at least in part on the type of policy for which compliance is required. Referring again to the employee that operates a forklift, because scheduled reminder is for the policy corresponding to OSHA training, if the employee has not complied with the policy, the reminder may need to be scheduled frequently, such as, every day, because the employee may be required to be in compliance before the employee can operate the forklift. Alternatively, the reminder for the policy regarding drug testing may only need to be scheduled once every 6 months.

At block 508 it is determined if scheduled reminders have been completed. If it is determined that scheduled reminders have not been completed, the process is repeated until the schedule reminders are completed. Accordingly, if it is determined that the scheduled reminders have been completed, no further action need to be taken with respect to reminder scheduling.

In various embodiments, the reminders may be scheduled for policies that have not been fully complied with. In alternative embodiments, the reminders may be scheduled on a periodic basis for updates.

As a result, compliance with human resource policies is facilitated including reminder scheduling of the policies.

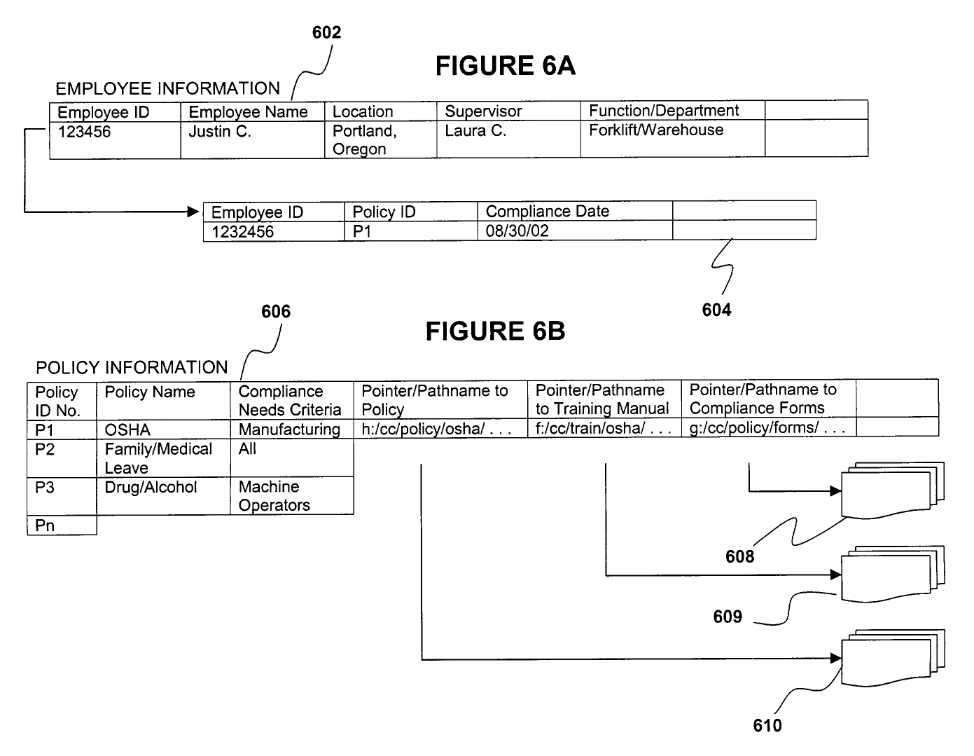

FIGS. 6A-6B illustrate data structure suitable for the present invention, in accordance with one embodiment. Illustrated in FIG. 6A is an employee information table 602 that may be representative of the data structure stored in the database 122. As previously alluded to, employee information table includes data corresponding to the employee, such as, but not limited to, employee ID, name, location, supervisor, function/department, and so forth. Further, employee information table 602 is shown having a sub-table 604. Sub-table 604 includes data corresponding to the employee's relationship to policies, such as, but not limited to, employee ID, policy ID, and compliance date. Both the policy ID and the compliance date are related to the employee ID.

Again referring back to the example of the employee who operates the forklift, employee information table 602 may include the data as shown in FIG. 6A.

Referring now to FIG. 6B, a policy information table 606 is shown. Policy information table 606 includes various policy data, such as, but not limited to, policy ID number, policy name, policy criteria, pointer/pathname to policy, pointer/pathname to training manual, pointer/pathname to policy forms, and so forth.

As illustrated in FIG. 6B, pointer/pathname data in table 606 corresponds to locations 608-610 on the database 122 included in the corporate server 108, where the data for the policies, training manuals, forms, and so forth reside.

Again referring to the example of the employee who operates a forklift at the organization's warehouse department, sub-table 604 may include data as shown in FIG. 6A. In particular, policy ID data may include P1 from the policy information table of FIG. 6B. That is, the employee that operates a forklift has a policy named OSHA associated with that employee. Further, in the sub-table of 604, the compliance date data may include a date at which the employee complied with the OSHA policy because in this example, the employee may not be able to operate the forklift unless the employee is in compliance with the OSHA policy (i.e., provided policy, training manual, policy forms, and so forth).

As a result of support of the PCMS 114 by an exemplary data illustrated in FIGS. 6A-6B, utilization of the various function blocks 116-120 are supported by the database 122, which in turn, advantageously provides for a more simplified way of ensuring an organization's compliance with human resource policies.

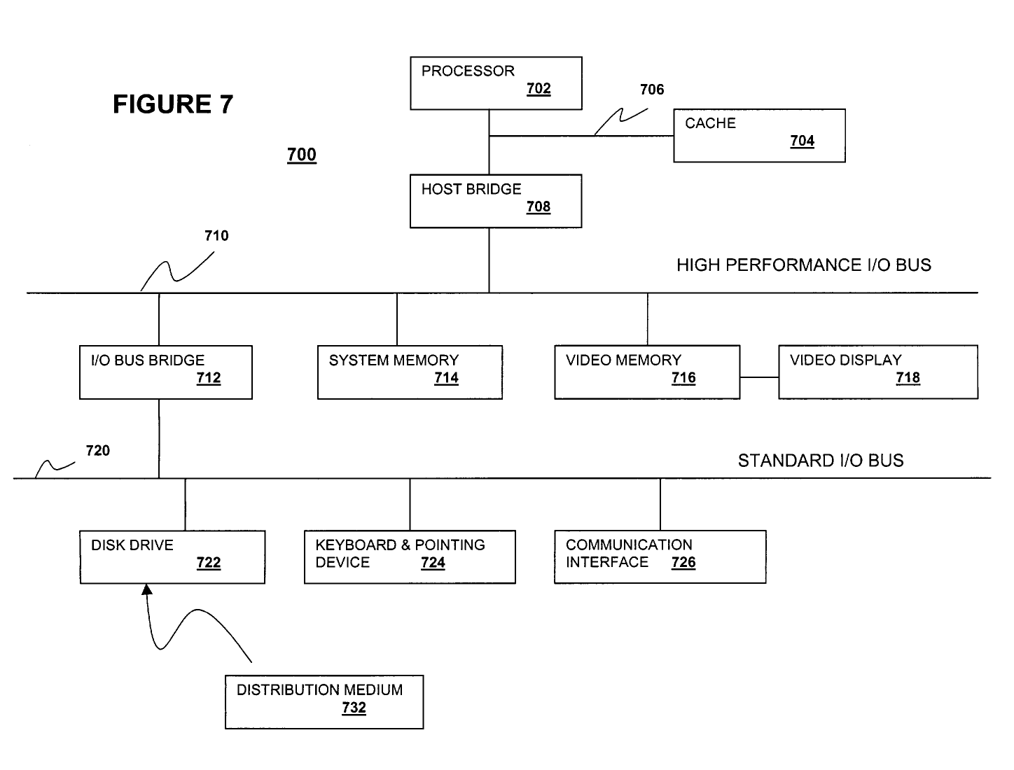

FIG. 7 illustrates one embodiment of a computer system suitable to be programmed with the PCMS of the present invention. As shown, for the illustrated embodiment, computer 700 includes processor 702, processor bus 706, high performance I/O bus 710 and standard I/O bus 720. Processor bus 706, and high performance I/O bus 710 are bridged by host bridge 708, whereas I/O buses 710 and 720 are bridged by I/O bus bridge 712. Coupled to processor bus 706 is cache 704. Coupled to high performance I/O bus 710 are system memory 714 and video memory 716, against which video display 718 is coupled. Coupled to standard I/O bus 720 are disk drive 722, keyboard and pointing device 724, and communication interface 726.

These elements perform their conventional functions known in the art. In particular, disk drive 722 and system memory 714 are used to store permanent and working copies of at least the relevant components of the PCMS incorporated with the teachings of the invention. The permanent copy may be pre-loaded into disk drive 722 in factory, loaded from distribution medium 732, or downloaded from a remote distribution source (not shown). Distribution medium 732 may be a tape, a CD, and DVD or other storage medium of the like. The constitutions of these elements are known. Any one of number implementations of these elements known in the art may be used to form computer system 700.

In general, those skilled in the art will recognize that the invention is not limited by the details described, instead, the invention can be practiced with modifications and alterations within the spirit and scope of the appended claims. The description is thus to be regarded as illustrative instead of restrictive on the invention.

Thus, an improved way of ensuring compliance with policies for an organization, in particular, human resource policies, has been described.

What is claimed is:

1. In a computing environment, a method of operation comprising:
receiving a change of a person within an organization, the received change having employee information corresponding to the change of the person;
storing the received employee information corresponding to the change of the person in a database;
updating the database with the received employee information corresponding to the change of the person; and
automatically providing, to the person, one or more policies for compliance certification, based at least in part on relevant parts of said updated employee information, to facilitate the organization's compliance with the policies.

2. The method of operation of claim 1, wherein the one or more policies comprise one or more human resource policies.

3. The method of operation of claim 1 further comprising:
determining if the person has fully certified compliance with the provided one or more policies; and
scheduling one or more reminders for the person to certify compliance with the one or more policies.

4. The method of operation of claim 3, wherein said scheduling of the one or more reminders comprises scheduling in accordance with one or more scheduling criteria of the one or more policies.

5. The method of operation of claim 4, wherein the method further comprises accepting the one or more reminder scheduling criteria for the one or more policies.

6. The method of operation of claim 1 further comprising:
determining if the person has a supervisory role; and
providing, to the person, one or more additional policies for compliance certification, based at least in part on the result of said supervisory role of the person determination.

7. The method of operation of claim 6 further comprising:
determining if the person has fully certified compliance with the further provided one or more additional policies; and
scheduling one or more reminders for the person to certify compliance with the additional provided one or more policies.

8. The method of operation of claim 1 further comprising:
determining if another person has assumed a supervisory role for the first time as a result of said change of the person; and
providing, to the person assuming the supervisory role for the first time, one or more policies for compliance certification, based at least in part on the result of said first assumption of supervisory role determination.

9. The method of operation of claim 8 further comprising:
determining if the person assuming the supervisory role for the first time has fully certified compliance with the provided one or more policies; and
scheduling one or more reminders for the person assuming supervisory role for the first time to certify compliance with the provided one or more policies.

10. The method of operation of claim 1, wherein said receiving a change of a person within an organization comprises receiving employee information corresponding to at least one of an ID, a name, a location, a supervisor, and a function/department associated with the person within the organization.

11. The method of operation of claim 1, wherein storing the received employee information corresponding to the change of the person comprises storing the received employee information corresponding to the change of the person in a database having stored policies corresponding to at least one of an ID number, a name, compliance criteria, an pointer/pathnames of various associated materials.

12. The method of operation of claim 1, wherein the method further comprises retrieving relevant ones of the stored updated employee information in performing said automatic provision of one or more policies for compliance certification.

13. The method of operation of claim 1, wherein said retrieving relevant employee information comprises retrieving updated employee information corresponding to at least one of a location, a supervisor, and a function/department associated with the person.

14. The method of operation of claim 1, wherein said providing of one or more policies for compliance certification comprises generating and displaying materials related to the one or more policies at a client device of the person.

15. The method of operation of claim 1, wherein said providing of one or more policies for compliance certification comprises providing at least one of a training manual for review, and policy forms to be filled in.

16. An apparatus comprising:
a storage medium having stored therein a plurality of programming instructions, which when executed, the instructions cause the apparatus to receive a change of a person within an organization, the received change having employee information corresponding to the change of the person, store the received employee information corresponding to the change of the person in a database, update the database with the received employee information corresponding to the change of the person, and automatically provide, to the person, one or more policies for compliance certification, based at least in part on relevant parts of said updated employee information, to facilitate the organization's compliance with the policies.

17. The apparatus of claim 16, wherein said programming instructions, which when executed, cause the apparatus to automatically provide, to the person, one or more human resource policies for compliance certification, based at least in part on the relevant parts of said employee information, to facilitate the organization's compliance with the one or more human resource policies.

18. The apparatus of claim 16, wherein said programming instructions, which when executed, cause the apparatus to determine if the person has fully certified compliance with the provided one or more policies, and schedule one or more reminders for the person to certify compliance with the one or more policies.

19. The apparatus of claim 18, wherein said programming instructions, which when executed, cause the apparatus to schedule in accordance with one or more scheduling criteria of the one or more policies.

20. The apparatus of claim 19, wherein said programming instructions, which when executed, cause the apparatus to accept the one or more reminder scheduling criteria for the one or more policies.

21. The apparatus of claim 16, wherein said programming instructions, which when executed, cause the apparatus to determine if the person has a supervisory role, and provide, to the person, one or more additional policies for compliance certification, based at least in part on the result of said supervisory role of the person determination.

22. The apparatus of claim 21, wherein said programming instructions, which when executed, cause the apparatus to determine if the person has fully certified compliance with the further provided one or more additional policies, and schedule one or more reminders for the person to certify compliance with the additional provided one or more policies.

23. The apparatus of claim 16, wherein said programming instructions, which when executed, cause the apparatus to determine if another person has assumed a supervisory role for the first time as a result of said change of the person, and provide, to the person assuming the supervisory role for the first time, one or more policies for compliance certification, based at least in part on the result of said first assumption of supervisory role determination.

24. The apparatus of claim 23, wherein said programming instructions, which when executed, cause the apparatus to determine if the person assuming the supervisory role for the first time has fully certified compliance with the provided one or more policies, and scheduling one or more reminders for the person assuming supervisory role for the first time to certify compliance with the provided one or more policies.

25. The apparatus of claim 16, wherein said programming instructions, which when executed, cause the apparatus to receive employee information corresponding to at least one of an ID, a name, a location, a supervisor, and a function/department associated with the person within the organization.

26. The apparatus of claim 16, wherein said programming instructions, which when executed, cause the apparatus to store the received employee information corresponding to the change in a database having stored policies corresponding to at least one of an ID number, a name, compliance criteria, an pointer/pathnames of various associated materials.

27. The apparatus of claim 16, wherein said programming instructions, which when executed, cause the apparatus to retrieve relevant ones of the stored updated employee information in performing said automatic provision of one or more policies for compliance certification.

28. The apparatus of claim 16, wherein said programming instructions, which when executed, cause the apparatus to retrieve updated employee information corresponding to at least one of a location, a supervisor, and a function/department associated with the person.

29. The apparatus of claim 16, wherein said programming instructions, which when executed, cause the apparatus to generate and display materials related to the one or more policies at a client device of the person.

30. The apparatus of claim 16, wherein said programming instructions, which when executed, cause the apparatus to provide at least one of a training manual for review, and policy forms to be filled in.

31. An article of manufacture having stored therein a plurality of programming instructions, which when executed, the instructions cause a machine to receive a change of a person within an organization, the received change having employee information corresponding to the change of the person, store the received employee information corresponding to the change of the person in a database, update the database with the received employee information corresponding to the change of the person, and automatically provide, to the person, one or more policies for compliance certification, based at least in part on relevant parts of said updated employee information, to facilitate the organization's compliance with the policies.

32. The article of manufacture of claim 31, wherein said programming instructions, which when executed, cause the machine to automatically provide, to the person, one or more human resource policies for compliance certification, based at least in part on the relevant parts of said employee information, to facilitate the organization's compliance with the one or more human resource policies.

33. The article of manufacture of claim 31, wherein said programming instructions, which when executed, cause the machine to determine if the person has fully certified compliance with the provided one or more policies, and schedule one or more reminders for the person to certify compliance with the one or more policies.

34. The article of manufacture of claim 33, wherein said programming instructions, which when executed, cause the machine to schedule in accordance with one or more scheduling criteria of the one or more policies.

35. The article of manufacture of claim 34, wherein said programming instructions, which when executed, cause the machine to accept the one or more reminder scheduling criteria for the one or more policies.

36. The article of manufacture of claim 31, wherein said programming instructions, which when executed, cause the machine to determine if the person has a supervisory role, and provide, to the person, one or more additional policies for compliance certification, based at least in part on the result of said supervisory role of the person determination.

37. The article of manufacture of claim 36, wherein said programming instructions, which when executed, cause the machine to determine if the person has fully certified compliance with the further provided one or more additional policies, and schedule one or more reminders for the person to certify compliance with the additional provided one or more policies.

38. The article of manufacture of claim 31, wherein said programming instructions, which when executed, cause the machine to determine if another person has assumed a supervisory role for the first time as a result of said change of the person, and provide, to the person assuming the supervisory role for the first time, one or more policies for compliance certification, based at least in part on the result of said first assumption of supervisory role determination.

39. The article of manufacture of claim 38, wherein said programming instructions, which when executed, cause the machine to determine if the person assuming the supervisory role for the first time has fully certified compliance with the provided one or more policies, and scheduling one or more reminders for the person assuming supervisory role for the first time to certify compliance with the provided one or more policies.

40. The article of manufacture of claim 31, wherein said programming instructions, which when executed, cause the machine to receive employee information corresponding to at least one of an ID, a name, a location, a supervisor, and a function/department associated with the person within the organization.

41. The article of manufacture of claim 31, wherein said programming instructions, which when executed, cause the machine to store the received employee information corresponding to the change of the person in a database having stored policies corresponding to at least one of an ID number, a name, compliance criteria, an pointer/pathnames of various associated materials.

42. The article of manufacture of claim 31, wherein said programming instructions, which when executed, cause the machine to retrieve relevant ones of the stored updated employee information in performing said automatic provision of one or more policies for compliance certification.

43. The article of manufacture of claim 31, wherein said programming instructions, which when executed, cause the machine to retrieve updated employee information corresponding to at least one of a location, a supervisor, and a function/department associated with the person.

44. The article of manufacture of claim 31, wherein said programming instructions, which when executed, cause the machine to generate and display materials related to the one or more policies at a client device of the person.

45. The article of manufacture of claim 31, wherein said programming instructions, which when executed, cause the machine to provide at least one of a training manual for review, and policy forms to be filled in.
